(19) United States
(12) Patent Application Publication
(10) Pub. No.: US 2012/0146275 A1
(43) Pub. Date: Jun. 14, 2012

(54) CLAMPING DEVICE

(75) Inventors: Jeongho Choi, Busan (KR); In Ho Jeong, Ulsan (KR)

(73) Assignee: HYUNDAI MOTOR COMPANY, Seoul (KR)

(21) Appl. No.: 13/170,970

(22) Filed: Jun. 28, 2011

(30) Foreign Application Priority Data
Dec. 8, 2010 (KR) 10-2010-0124905

(51) Int. Cl. B25B 5/06

(52) U.S. Cl. 269/226; 269/225

(57) ABSTRACT

Disclosed is a clamping device which reduces the overall size typical clamping devices used for similar operations by implementing a motor as a driving source and maintaining a clamping force applied to a panel constantly through accurate stroke control by incorporating a worm gear. More specifically, the clamping device includes a locator on which a panel is seated and a driving motor incorporated into a portion of the locator. A gear box rotates a rotation rod by receiving a rotational force from the driving motor and a clamper connected with the rotation rod, clamps the panel seated on the locator.

### CROSS-REFERENCE TO RELATED APPLICATION

This application claims priority to and the benefit of Korean Patent Application No. 10-2010-0124905 filed in the Korean Intellectual Property Office on Dec. 8, 2010, the entire contents of which are incorporated herein by reference.

### BACKGROUND OF THE INVENTION

(a) Field of the Invention

The present invention relates to a clamping device, and more particularly, to a motor driven clamping device capable of reducing an overall size of the clamping device by using a motor as a driving source and maintaining a clamping force applied to a panel consistently through accurate stroke control by incorporating a worm gear.

(b) Description of the Related Art

In general, a clamping device is used to fix a material panel so as to prevent the material panel from being moved at the time of performing processing operations such as cutting, plating, welding, and the like of the material panel. The clamping force or restriction portion of a clamping device is different depending on a cross-sectional shape of the material panel for each processing operation and the structure of the panel clamping device is also different.

The clamping device 1 includes a locator 3 mounted on one portion of a carriage or jig (not shown), an actuating cylinder 5 actuated by air pressure or oil pressure, and a clamper 9 having one portion hingedly-fixed to an upper portion of the locator 3 and a rear end hingedly-mounted on a front end of an actuating rod 7 of the actuating cylinder 5 to clamp and/or unclamp a panel 8 by hingedly-actuating with respect to the locator 3 with reciprocating motion of the actuating rod 7, as shown in FIG. 5.

That is, when actuating pressure is supplied to the actuating cylinder 5, the actuating rod 7 moves up and a front end of the clamper 9 moves down by hinge-actuation of the clamper 9 to clamp and fix the panel 8 seated on the carriage, and as a result, post processes such as welding, and the like are performed.

However, since the known clamping device uses the actuating cylinder 5 as a power source, the layout of connection pipes installed to supply the air pressure or oil pressure for performing the actuating of the actuating cylinder 5 becomes complicated and it is difficult to control the actuating pressure, and as a result, the clamping force of the clamping device is not constant.

Further, since the actuating cylinders should be upsized in order to provide an adequate clamping force for certain panels requiring a large clamping force, an overall size and a manufacturing cost must be increased and an additional actuating pressure supplying device for supplying the actuating pressure to the actuating cylinder should be provided in addition to an adequate power supply. Furthermore, as a result, spatial utilization of a workplace deteriorates.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to reduce the overall size of a clamping device by using a motor as a driving source and maintaining a clamping force applied to a panel consistently through accurate stroke control by incorporating into the device a worm gear.

Further, the present invention provides a clamping device which reduces manufacturing costs through simplification of the overall configuration and layout by removing the cylinder and hinge structure and reducing weight due to size reduction.

An exemplary embodiment of the present invention provides a clamping device which includes a locator on which a panel is seated and a driving motor provided at one portion of the locator. A gear box rotates a rotation rod by receiving a rotational force of the driving motor. Additionally, a clamper is connected with the rotation rod and to clamp the panel seated on the locator.

More specifically, the gear box may include: a housing with an insertion hole and a mounting space; and a gear unit installed in the insertion hole and the mounting space and connected with the rotation rod. The gear unit may also include: a worm provided in the insertion hole and connected with the driving motor; and a worm gear meshing with the worm and having a rotation hole joined with the rotation rod to rotate the rotation rod with rotation of the worm.

The clamping device may further include a supporting hole formed in the gear unit and supporting the rotation rod and at least one damper mounted between the worm gear and the rotation hole in the worm gear to absorb an external force transferred through the clamper and vibration of the worm. The dampers may be mounted at regular intervals with being spaced at a predetermined angle in a circumferential direction of the worm gear around the rotation hole. For example, the predetermined angle may be 120 degrees and the dampers may be made of a material containing a nylon resin and rubber.

The driving motor in some embodiments of the present invention may be embodied as a DC motor of which rpm and a rotational direction are controllable.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view of a clamping device according to an exemplary embodiment of the present invention.

FIG. 2 is a front view of a clamping device according to an exemplary embodiment of the present invention.

FIG. 3 is a cross-sectional view taken along line A-A of FIG. 1.

FIG. 4 is a use state diagram of a clamping device according to an exemplary embodiment of the present invention.

FIG. 5 is a configuration diagram of a clamping device in the related art.

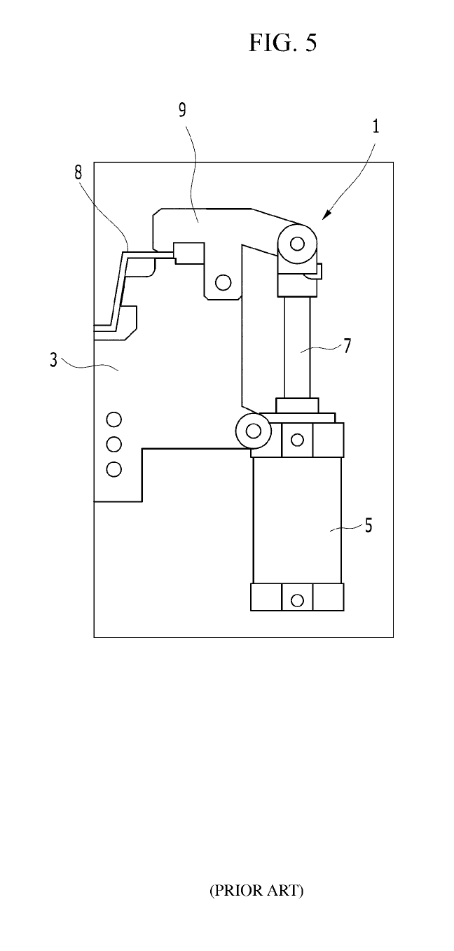

### DESCRIPTION OF SYMBOLS

110: Locator
111: Seating surface
120: Driving motor
130: Gear box
131: Housing
133: Insertion hole
135: Mounting space
137: Supporting hole
139: Gear unit
140: Rotation rod
143: Worm
145: Worm gear
147: Damper
149: Rotation hole
160: Clamper

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

An exemplary embodiment of the present invention will hereinafter be described in detail with reference to the accompanying drawings.

Exemplary embodiments described in the present specification and a configuration shown in the drawings are just the most preferable exemplary embodiment of the present invention, but are not limited to the spirit and scope of the present invention. Therefore, it should be understood that there may be various equivalents and modifications capable of replacing them at the time of filing of the present application.

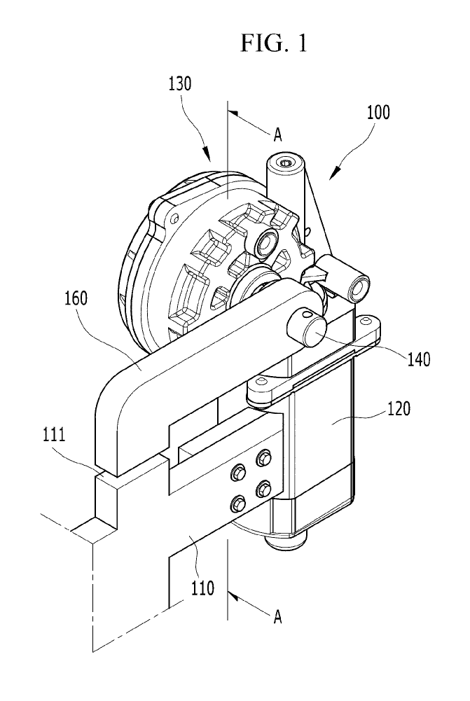

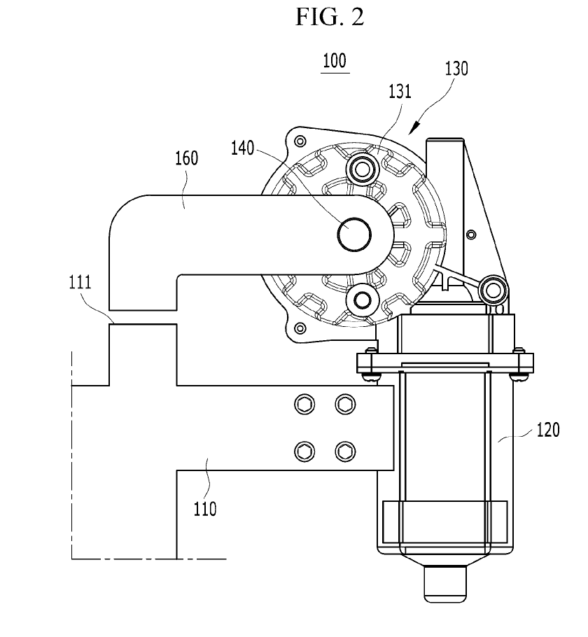

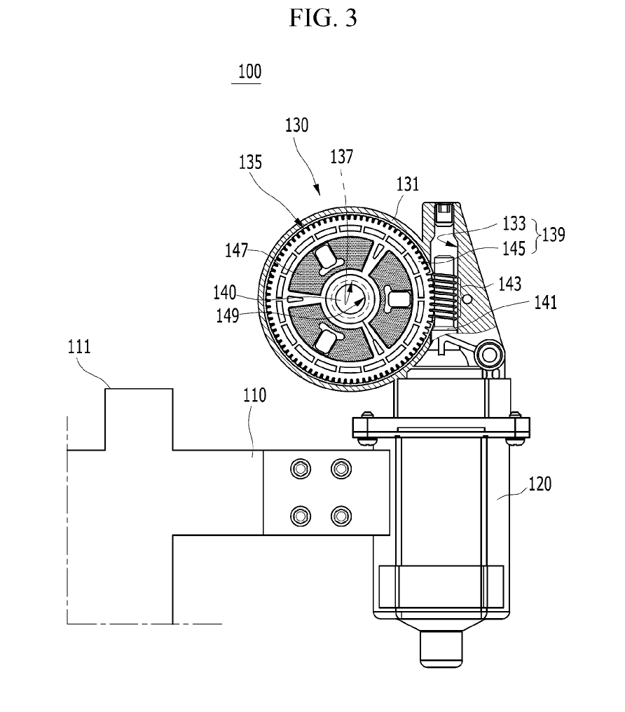

FIG. 1 is a perspective view of a clamping device according to an exemplary embodiment of the present invention, FIG. 2 is a front view of a clamping device according to an exemplary embodiment of the present invention, and FIG. 3 is a cross-sectional view take along line A-A of FIG. 1.

A clamping device 100 according to an exemplary embodiment of the present invention, which is used to clamp and fix a panel, includes a locator 110, a driving motor 120, a gear box 130, and a clamper 160, as shown in FIGS. 1 and 2.

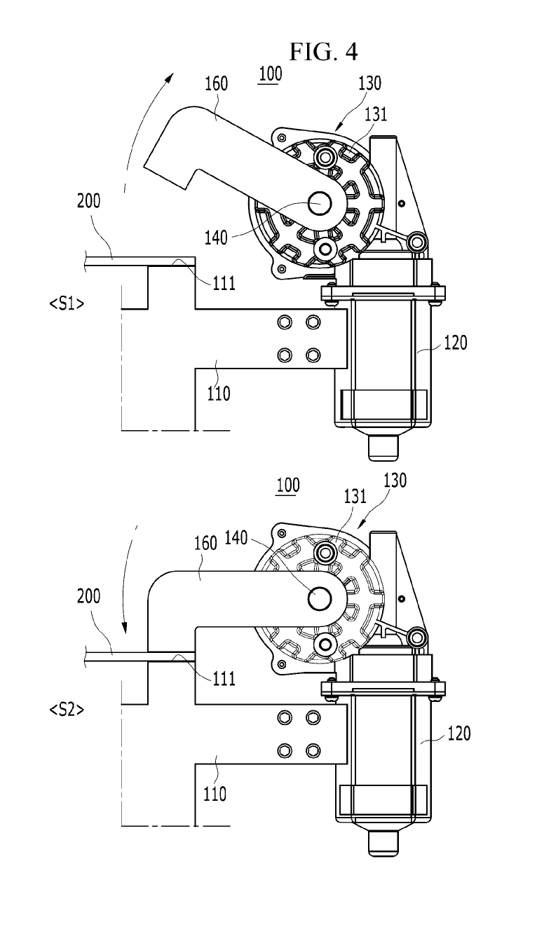

In the illustrative embodiment of the present invention, a seating surface 111 on which a panel 200 of FIG. 4 is seated is formed in the locator 110. In the illustrative embodiment, the driving motor 120 is mounted on one portion of the locator 110. The driving motor 120 may be embodied as a small DC motor of which rpm and a rotational direction can be controlled, for example a servo motor, stepping motor and so on.

The gear box 130 includes a housing 131 with an insertion hole/aperture 133 and a mounting space 135 and a gear unit 139 installed in the insertion aperture 133 and the mounting space 135. The gear unit 139 includes a worm 143 provided in the insertion aperture 133 and connected with the driving motor 120 and a worm gear 145 meshing or correlating with the worm 143 so as to allow the worm 143 to cause the worm gear to move as the worm 143 rotates as a result of the rotational force of the driving motor 120.

In addition, the clamper 160 is mounted on one end of a rotation rod 140 that projects from within the gear box 130 to the outside of the gear box 130 and rotates by actuation of the driving motor 120 (which is applied to the worm 143 and the gear 145) to clamp the panel onto the seating surface 111 of the locator 110. A rotation aperture 149 is formed in the worm gear 145, such that the rotation rod 140 is joined to the rotation aperture 149 and the rotation rod 140 rotates with rotation of the worm gear 145. More specifically, the gear box 130 includes a housing 131, a supporting hole 137, a gear unit 139, and a worm rod 141, as shown in FIG. 3.

In particular, the housing 131 includes the insertion aperture 133 into which the worm 143 is inserted and the mounting space 135 formed to install the worm gear 145 therein. In the exemplary embodiment, the rotation rod 140 is rotatably inserted into the supporting aperture 137, which supports the rotation rod 140.

The clamping device according to the exemplary embodiment of the present invention further includes at least one damper 147 mounted between the worm gear 145 and the rotation aperture 149 in the worm gear 145 to absorb an external force transferred through the clamper 160 and vibration transferred from the worm 143.

The dampers 147 are mounted at regular intervals, spaced at a predetermined angle in a circumferential direction of the worm gear 145 around the rotation aperture 149, e.g., the predetermined angle may be about 120 degrees. That is, three dampers 147 may be mounted between the worm gear 145 and the rotation aperture 149 at positions spaced at intervals of about 120 degrees in the circumferential direction of the worm gear 145. The damper 147 may be made of a material containing a nylon resin and rubber to satisfy both the clamping force and the damping function.

Hereinafter, operations and actions of the clamping device 100 according to the exemplary embodiment of the present invention configured as above will be described in detail.

FIG. 4 is a use state diagram of a clamping device according to an exemplary embodiment of the present invention. First, as shown in S1 of FIG. 4, the driving motor 120 rotates to rotate the worm gear 145 in a clockwise direction of the figure. Therefore, while the rotation rod 140 that press-fits in the rotation hole 149 of the worm gear 145 rotates together with the worm gear 145, the rotation rod 140 rotates the clamper 160 approaching the seating surface 111 of the locator 110 upwards. In this state, a worker or a robot may seat a panel 200 to be clamped onto the seating surface 111 of the locator 110.

Once the panel is ready to be clamped, the driving motor 120 rotates the worm gear 145 in a counterclockwise direction of the figure, as shown in S2 of FIG. 4. In doing so, the rotation rod 140 rotates the clamper 160 downwards while rotating together with the worm gear 145. As a result, the damper 160 clamps the panel 200 seated on the seating surface 111 of the locator 110.

Herein, at the time of clamping the panel, or when the external force is transferred from the clamper 160 or vibration generated by the driving motor 120 is transferred from the worm 143, the dampers 147 absorb the external force and vibration. As a result, the damper 147 can improve durability of the worm gear 145 and prevent the panel from being unclamped due to a decrease of the clamping force by preventing the worm gear 145 from being affected by the worm 143 or minutely rotated by the external force or vibration.

Further, the rotational force of the driving motor 120 is controlled so as to apply a constant clamping force to the clamped panel at all times. Although not shown in the figure, the clamping force can be controlled constantly and consistently by using a pressure sensor measuring the clamping force.

Accordingly, the clamping device 100 according to the exemplary embodiments of the present invention configured as above reduces the overall size requirements of the clamping device by using a motor as a driving source and maintaining a clamping force applied to a panel constantly through accurate stroke control by incorporating a worm gear 145. Thus, manufacturing cost savings can be realized through simplification of a configuration and layout by removing a cylinder employing an additional link member and a hinge structure and weight can be reduced due to size reduction.

Further, as a motor is used as a driving source, connection pipes for supplying air pressure or oil pressure, and an additional air pressure or oil pressure supplying devices other than a power supply source can be removed at the time of adopting a known cylinder, as a result, spatial utilization can be improved.

In addition, a stroke can be accurately controlled through the worm gear to supply a constant clamping force, and as a result, cracks or scratches can be prevented from being generated on the clamped panel, thereby improving marketability.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A clamping device, comprising:
a locator on which a panel is seated;
a driving motor incorporated into a portion of the locator;
a gear box rotating a rotation rod by receiving a rotational force of the driving motor; and
a clamper connected with the rotation rod and clamping the panel seated on the locator.

2. The device of claim 1, wherein the gear box includes:
a housing with an insertion aperture and a mounting space; and
a gear unit installed in the insertion hole and the mounting space and connected with the rotation rod.

3. The device of claim 2, wherein the gear unit further includes;
a worm provided in the insertion aperture and connected with the driving motor; and
a worm gear meshing with the worm and having a rotation aperture joined with the rotation rod to rotate the rotation rod with rotation of the worm.

4. The device of claim 3, further comprising: a supporting aperture formed in the gear unit and supporting the rotation rod.

5. The device of claim 3, further comprising:
at least one damper mounted between the worm gear and the rotation aperture in the worm gear to absorb an external force transferred through the clamper and vibration of the worm.

6. The device of claim 5, wherein the dampers are mounted at regular intervals, the intervals spaced at a predetermined angle in a circumferential direction of the worm gear around the rotation hole.

7. The device of claim 6, wherein the predetermined angle is 120 degrees.

8. The device of claim 6, wherein the dampers are made of a material containing a nylon resin and rubber.

9. The device of claim 1, wherein the driving motor is embodied as a DC motor of which rpm and a rotational direction are controllable.

10. A method for operating the clamping device, comprising:
providing a panel on a locator;
rotating a rotation rod, by a gear box, by receiving a rotational force of a driving motor incorporated into a portion of the locator; and
clamping the panel seated on the locator by a damper connected with the rotation rod, wherein a constant force is applied by the driving motor to the rotation rod to supply a constant force to the panel.

11. The method of claim 10, further comprising:
absorbing an external force transferred through the clamper and vibration of a worm by at least one damper mounted between the worm gear and a rotation aperture in the worm gear.

12. The method of claim 10, wherein the dampers are mounted at regular intervals, the intervals spaced at a predetermined angle in a circumferential direction of the worm gear around the rotation aperture.

13. The method of claim 12, wherein the predetermined angle is 120 degrees.

14. The device of claim 12, wherein the dampers are made of a material containing a nylon resin and rubber.

15. The device of claim 10, wherein the driving motor is embodied as a DC motor of which rpm and a rotational direction are controllable.
